(19) United States
(12) Patent Application Publication
(10) Pub. No.: US 2009/0157746 A1
(43) Pub. Date: Jun. 18, 2009

(54) Method For Capturing Utility Equipment Data

(75) Inventors: Randal K. More, Lafayette, NY (US); Christopher C. DiLiberto, Clay, NY (US); Thomas M. Petrik, Baldwinsville, NY (US); Lynn M. Bourdon, Phoenix, NY (US); Andrew W. Beardslee, Fabius, NY (US); David A. Mohammed, Fayetteville, NY (US)

Correspondence Address: HODGSON RUSS LLP;THE GUARANTY BUILDING, 140 PEARL STREET, SUITE 100, BUFFALO, NY, 14202-4040, US

(73) Assignee: OSMOSE UTILITIES SERVICES, INC., Buffalo, NY (US)

(21) Appl. No.: 11/955,619

(22) Filed: Dec. 13, 2007

(51) Int. Cl. G06F 7/00; G06F 17/30

(52) U.S. Cl. 707/104.1; 707/E17.001; 707/E17.019

(57) ABSTRACT

A method for capturing information regarding utility equipment installed at a location comprises the steps of making a site visit to the location; recording voice narration about the utility equipment as the utility equipment is inspected by a narrator during the site visit; recording video of the utility equipment during the site visit; recording identification information for identifying the utility equipment; and entering attribute data corresponding to the utility equipment into a database, wherein the entered attribute data includes data derived from the recorded voice narration, the recorded video, and the recorded identification information. In an embodiment of the invention, the steps of recording voice narration, recording video, and recording identification information are performed simultaneously using a camcorder connected to a GPS receiver via an encoder such that location coordinates are recorded as audio frequency shift keying (AFSK) tones in an audio channel of the camcorder.

### FIELD OF THE INVENTION

The invention relates to the field of services for auditing and maintaining utility equipment such as utility poles, transformers, power lines and wires, telecommunications cables and lines, switches, underground pads, meters, and other related utility equipment.

### BACKGROUND OF THE INVENTION

It is known to audit utility equipment by dispatching field technicians carrying mobile digital devices such as notebook computers or hand-held portable digital assistants (PDAs) to utility pole locations, where the field technicians observe conditions and characteristics of the utility equipment and enter corresponding data into the digital device. The entered data may then be merged into a customer database that includes data about a customer's utility equipment. The information in the customer database is useful for scheduling maintenance tasks, allocating costs if the utility equipment is shared with another party, and identifying potentially dangerous conditions. In this context, “customers” are typically utility or telecommunication companies owning and/or leasing utility equipment and pole space.

While the auditing method described above is helpful to customers, it does have recognized drawbacks. One drawback is that there is no way to perform quality assurance or quality control to confirm the accuracy of entered data without revisiting the equipment location. In this regard, the entered data is based entirely on subjective human observation, which is prone to error, and there is no objective information to corroborate the data entered by a particular field technician.

Another drawback is that it is difficult to track or assess the productivity and diligence of the field technician crews. The crews are relied upon to visit each and every assigned pole or other equipment location, however under current methods it is not possible to check whether a crew has actually visited each location to gather data.

A further drawback of current methods is that a customer representative and/or an auditor field technician must sometimes revisit an equipment location if there is a specific question about the equipment that cannot be answered based on the entered data. In cases of suspected storm damage, more detailed advance information about the arrangement of utility equipment at a particular location is quite helpful to repair crews.

### SUMMARY OF THE INVENTION

It is therefore an object of the present invention to provide a method for capturing data about utility equipment that provides both subjective information reflecting a field technician's expertise and objective information that corroborates and supplements the subjective information.

It is another object of the present invention to provide a method for capturing data about utility equipment that enables quality assurance to be performed to confirm the accuracy of equipment data entered in a customer database.

It is yet another object of the present invention to provide a method for capturing data about utility equipment that enables the travel path of a field crew to be tracked during an audit operation to ensure that each equipment location is actually visited in an efficient manner.

It is a further object of the present invention to provide a method for capturing data about utility equipment that enables a customer to make a “virtual visit” to a chosen equipment location without sending a crew to visit the location in person.

The present invention provides a method for capturing information regarding utility equipment installed at a location so as to achieve the objects mentioned above. The utility equipment may include, but is not limited to, utility poles, transformers, power lines and wires, telecommunications cables and lines, switches, underground pads, meters, and other related utility equipment. The method generally comprises the steps of making a site visit to the location; recording voice narration about the utility equipment as the utility equipment is inspected by a narrator during the site visit; recording video of the utility equipment during the site visit; recording identification information for identifying the utility equipment; and entering attribute data corresponding to the utility equipment into a database, wherein the entered attribute data includes data derived from the recorded voice narration, the recorded video, and the recorded identification information. The steps of recording voice narration, recording video, and recording identification information may be performed simultaneously by a field technician. In a particular embodiment, the identification information includes location coordinates corresponding to the location where the utility equipment is installed, wherein the location coordinates are provided automatically by location sensing equipment such as a global positioning system (GPS) receiver in communication with a GPS receiver. The field technician may use an audio-visual recorder linked to the GPS receiver through an encoder, whereby location coordinates obtained by the GPS receiver are converted to audio frequency shift keying (AFSK) data and stored in a single digital file together with recorded video and voice narration data streams corresponding to the location.

The steps of recording voice narration and recording video may be performed according to a predetermined sequential protocol, and the step of entering attribute data may then be performed in accordance with the sequential protocol to facilitate data entry.

The method may comprise further steps of receiving additional data about the utility equipment from an outside source, such as a customer database, and integrating the additional data into the database. For example, mapping data from a customer geographic information system (GIS) may be integrated with captured data to provide an interactive map of utility equipment, whereby an end user may view video and listen to narration corresponding to utility equipment at a particular location selected from the interactive map.

The method may also comprise quality assurance steps of reviewing the recorded voice narration and the recorded video in conjunction with the entered attribute data to check accuracy of the entered attribute data and, if necessary, correcting the entered attribute data.

As will be appreciated from the instant specification, the method of the present invention captures verifiable subjective information and objective information about specified utility equipment which may be referenced by a customer or other end user. The information in the database may be accessed in its raw form by a customer, or processed to provide a deliverable report of desired format to a customer.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram generally illustrating a method for capturing utility equipment data in accordance with an embodiment of the present invention;

FIG. 2 is a schematic view showing the format of a digital file storing captured utility equipment data in accordance with an embodiment of the present invention;

FIG. 3 is a flow diagram of the method as applied, for example, to a joint use audit; and

FIG. 4 is a flow diagram of the method as applied, for example, to a network inventory audit.

### DETAILED DESCRIPTION OF THE INVENTION

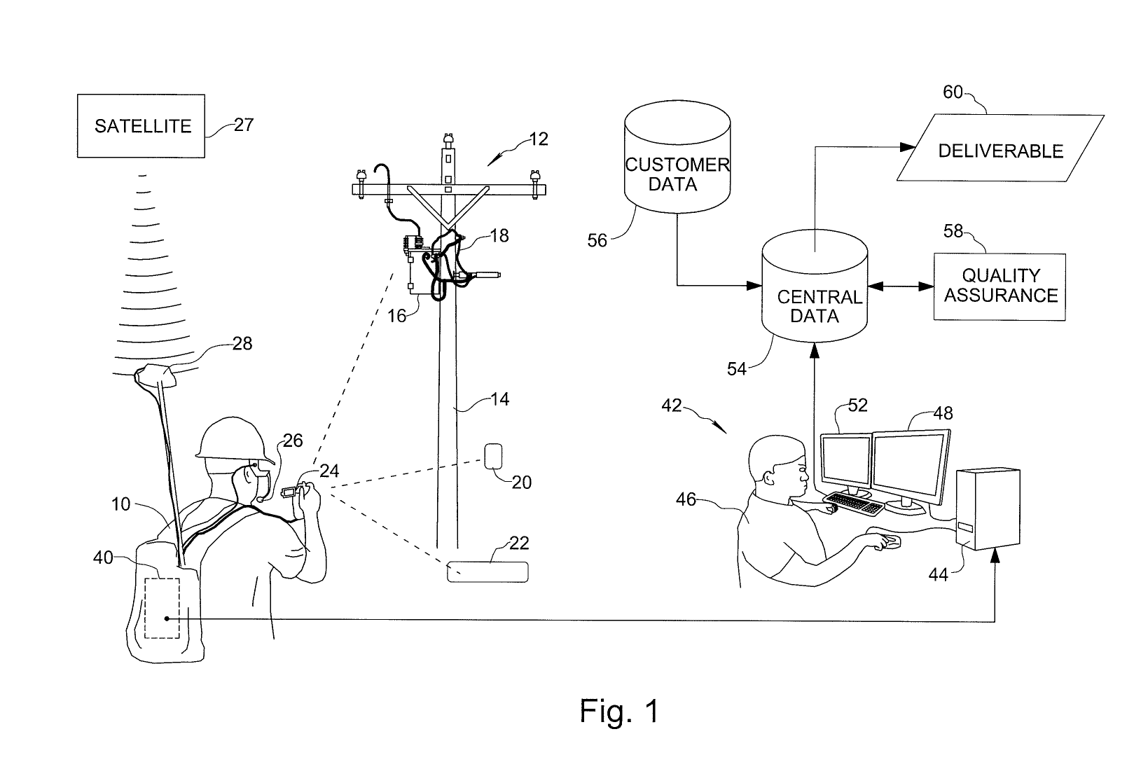

An embodiment of the present invention is depicted schematically in FIG. 1. A field technician 10 is dispatched to a location where utility equipment 12 is installed in order to collect information about the utility equipment. As used herein, “utility equipment” is intended to refer in a non-limiting sense to utility poles, power lines, telecommunication cables and lines, transformers, switches, fuses, underground utility pads, meters, and other equipment installed at a location to deliver electric or telecommunication service to one or more users, or to support, access, or protect such equipment. In the embodiment illustrated in FIG. 1, utility equipment 12 is shown as including a utility pole 14, a transformer 16, power lines 18, a meter 20, and an underground pad 22, however the types and arrangement of utility equipment will vary from location to location. The field technician 10 may be part of a field crew that has received instructions to audit specified utility equipment locations by visiting each location. The instructions may include a map indicating the locations to be audited and a description of the type of audit, for example a “joint use” audit for determining allocation of shared pole space and equipment between or among two or more joint users, or a “network inventory” audit for determining quantities, types, and condition of utility equipment owned by a utility company or other audit customer. Depending upon the type of audit, the instructions may include a sequential protocol to be followed for gathering specific types of information in a predetermined sequential order, as will be described in connection with non-limiting examples presented below.

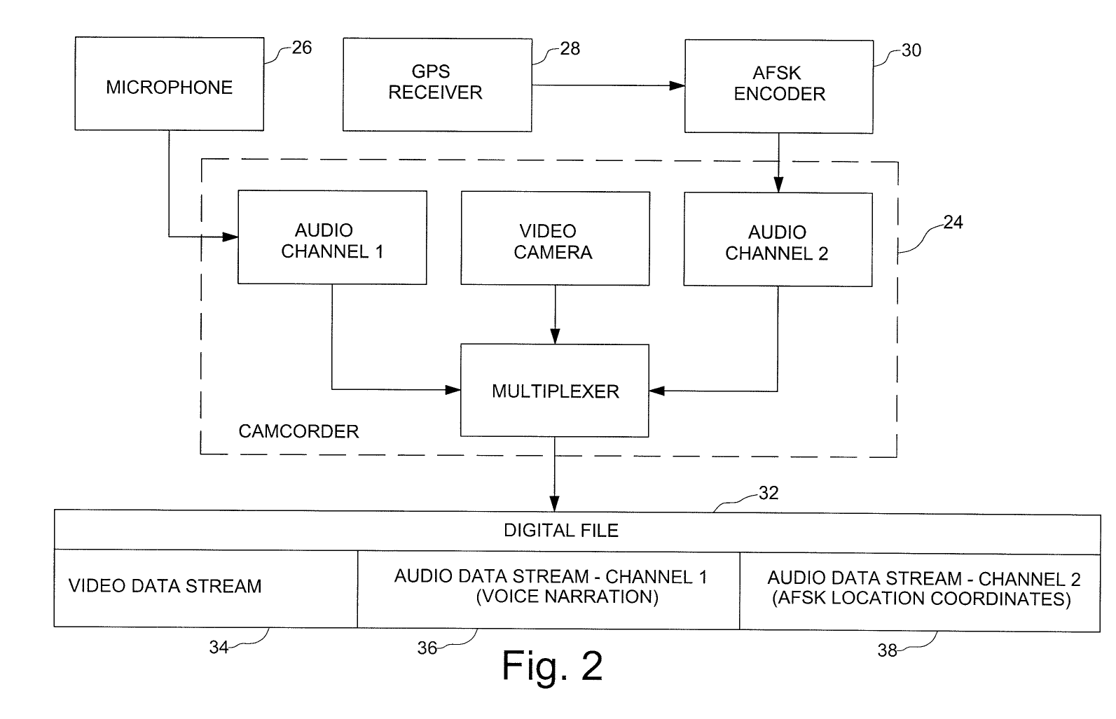

Field technician 10 is equipped with a digital audio-video recorder (“camcorder”) 24, a headset microphone 26 connected to a first audio channel of camcorder 24, and a GPS receiver 28 connected to a second audio channel of camcorder 24 via an encoder 30. In an embodiment of the present invention, location coordinates detected by GPS receiver 28 based on communication with GPS satellite 27 are converted to audio frequency shift keying (AFSK) data by encoder 30, whereby the location coordinates are represented by a series of audio tones. While FIG. 2 shows AFSK encoder 30 as being separate from camcorder 24, it will be understood that AFSK encoder 30 may be incorporated into camcorder 24. Camcorder 24 may be used to record video images, voice narration in the first audio channel, and AFSK data representative of GPS location coordinates in the second audio channel. The video, audio narration, and AFSK encoded audio data may be multiplexed and stored in a single digital file 32 having a video data stream 34, a first channel audio data stream 36, and a second channel audio data stream 38. Digital file 32 may have a standard format, for example MPEG-2, MPEG-4, or other file format supported by camcorder 24. A storage unit 40 is connected to camcorder 24 and includes a digital storage medium such as a hard drive, optical drive, memory stick, disc, or other storage medium for storing one or more digital files 32. Storage unit 40 may be carried in a backpack worn by field technician 10. When equipped as described above, field technician 10 may record video of utility equipment 12 and voice narration describing the recorded video images, while location coordinates are recorded automatically in an audio channel of camcorder 24.

As will be understood, the location coordinates detected by GPS receiver 28 serve as identification information for identifying the utility equipment by its location. However, other identification information may be recorded. For example, a pole number, street address, or other identification information may be recorded on video and/or spoken as part of the recorded narration.

Camcorder 24 may be any commercially available digital camcorder. It may be advantageous to use a camcorder having a relatively high optical zoom capability, for example 10× or higher, to enable field technician 10 to capture high resolution video images of equipment mounted near the top of a utility pole without climbing the pole.

The voice narration may be provided by the field technician 10 who serves as narrator while simultaneously operating camcorder 24 to record video showing various aspects of utility equipment 12 and to record the narration. Alternatively, the narration may be provided by another crew member (not shown) wearing microphone 26 and teamed with the camcorder operator 10.

Attention is directed again to FIG. 1. The digital files stored on storage medium 40 are transferred to a data entry station generally identified as 42. File transfer may be by wireless transmission, uploading to and downloading from a network server, copying files directly from storage unit 40 directly to a playback computer 44, or copying files to a portable medium such as a flash memory or DVD that can be read by playback computer 44.

At data entry station 42, a data entry person 46 plays back the digital files on playback computer 44, viewing the video on a playback display 48 and listening to the recorded narration on speaker 50 or a headset connected to playback computer 44. Playback computer 44 may be configured with a decoder for converting the AFSK data in second channel audio data stream 38 to location coordinates displayable on playback display 48 and readable by data entry person 46. Data entry station 42 also includes a data entry terminal 52 on which an interface program is executed by which data entry person 46 may access a central database 54 storing attribute data regarding utility equipment. Data entry person 46 enters attribute data corresponding to the audited utility equipment into central database 54, wherein the entered attribute data includes data derived from the recorded voice narration, the recorded video, and the recorded identification information.

In an aspect of the present invention, the steps of recording voice narration and recording video may be performed according to a predetermined sequential protocol provided to field technician 10, and the step of entering attribute data may be performed in accordance with the predetermined sequential protocol by data entry person 46 who has been advised of the sequential protocol. In this way, the data entry step for each audited location is expedited to some extent.

The method of the present invention may further comprise the step of storing the recorded voice narration (subjective information) and the recorded video and identification information (objective information) in central database 54. For example, each digital file 32 may be stored in central database 54 in association with the entered attribute data to which the digital file corresponds.

Central database 54 may be linked to a customer database 56 containing additional data which the customer has collected about its utility equipment at various locations. For example, customer database 56 may be a GIS database that includes local mapping information and related data about utility equipment installed at locations within a geographic region. In accordance with an aspect of the present invention, additional data from an outside source, for example customer database 56, may be received and integrated into central database 54. By way of further example, mapping data from a customer GIS may be integrated with captured data so that an interactive map of utility equipment may be generated. Such an interactive map may allow an end user to view video and listen to narration corresponding to utility equipment at a particular location by selecting the location on the interactive map.

The method of the present invention may further comprise quality assurance or quality control steps performed by a quality assurance system 58, indicated schematically in FIG. 1, to reduce errors in the data stored in central database 54. Quality assurance system 58 reviews the recorded voice narration and the recorded video in conjunction with the entered attribute data to check accuracy of the entered attribute data and, if necessary, corrects the entered attribute data. Quality assurance system 58 may be a qualified individual or a team of qualified individuals manually reviewing the stored attribute data against the associated video, audio narration, and location coordinate data to find and correct errors. Alternatively, or additionally, quality assurance system 58 may include software for automatically detecting and correcting data errors.

Central database 54, alone or in conjunction with customer database 56, provides source data which may be used to create a deliverable 60 for a customer. Deliverable 60 may be an electronic or hardcopy report, a secure website, or any other output for use by the customer. Deliverable 60 may have a standard format offered to a plurality of customers, or it may have a customized format provided to a particular customer and designed according to specifications provided by such customer.

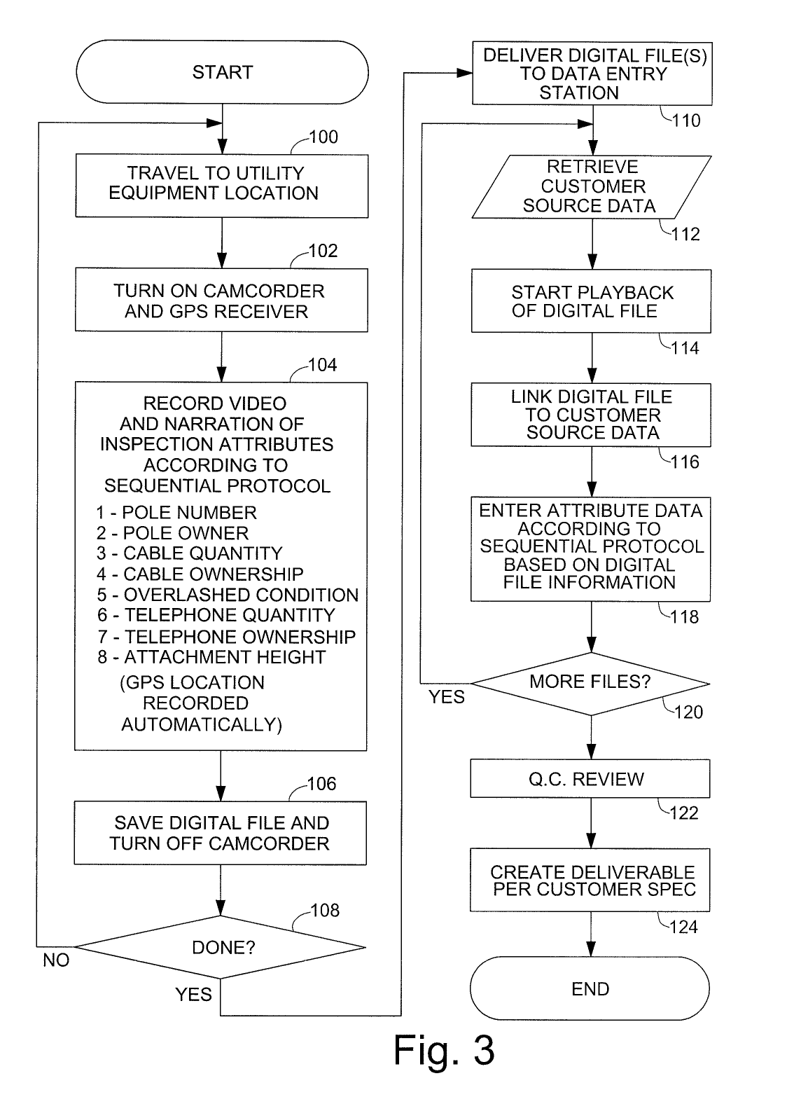

Attention is directed now to FIG. 3, which is a flow diagram of the method as applied to a “joint use” audit. A joint use audit is used in the utility industry to allocate costs and resolve other issues between or among different parties, most commonly electric companies and telecommunications companies, who may share utility pole space for their respective equipment. In block 100, the field technician 10 travels to an initial location to begin the audit. The field technician may be provided with a map specifying the locations to be audited and perhaps a preferred sequence of the visits for improved efficiency. Once at the location, field technician 10 turns on camcorder 24 and GPS receiver 28 in accordance with block 102, and proceeds to record video and to narrate the video as it is recorded in accordance with block 104. The video and voice narration may be carried out in accordance with a predetermined sequential protocol. For example, the field technician starts by recording video of the pole number if the pole is visibly tagged, and at the same time reading the pole number aloud. The field technician may then record video evidence of pole ownership, if available, and say the pole owner's name as part of the voice narration. In similar fashion, the field technician may record video and voice commentary with respect to other items of interest, such as cable attachment quantity, cable attachment ownership, overlashed condition (whether an additional wire is wrapped around an original attachment so it does not use up additional pole space), telephone line quantity, telephone line ownership, and estimated height of attachments. Of course other items may be included as desired. The GPS location coordinates are recorded automatically in a manner described above. Once the field technician has completed the recording protocol, the created digital file 32 is written to storage unit 40 and camcorder 24 may be turned off as indicated in block 106. A decision block 108 is then reached to determine whether the field technician is done visiting all locations in the audit or has completed his or her shift. If not, flow is returned to block 100 and the field technician visits the next location and repeats the process steps described above. If so, flow proceeds to block 110. In this step, the recorded digital files stored on storage unit 40 are delivered to data entry station 42. As mentioned above, file transfer may be by wireless transmission, uploading to and downloading from a network server, copying files directly from storage unit 40 directly to a playback computer 44, or copying files to a portable medium such as a flash memory of CD-ROM readable by playback computer 44.

Continuing with blocks 112 and 114, the data entry person 46 may execute software to retrieve customer source data from customer database 56, and also start playing back digital files 32. The data entry person may create new records or update existing records in central database 54, each record corresponding to a location for which a digital file 32 has been recorded. In this regard, each record in central database 54 may include, directly or by a file path link, the actual digital file 32 for the location corresponding to that record, whereby digital file 32 is accessible and available for playback through central database 54. The data entry person 46 may also link records from customer database 56 with records in central database 54 pursuant to block 116, thereby matching data from customer database 56 with corresponding records in central database 54. Block 118 indicates that as the audio and video information is played back and the GPS location coordinates are displayed on playback display 48, data entry person 46 enters attribute data corresponding to the utility equipment into central database 54 using data entry terminal 52, wherein the entered attribute data includes data derived from the recorded voice narration, the recorded video, and the recorded location coordinates. For example, a plurality of fields may be provided for each new record, and the field values entered by data entry person 46 depend upon the video, voice narration, and location coordinates communicated during playback. In this regard, a given field may be derived from any one, any two, or all three of the video, voice narration, and location coordinates.

As indicated by decision block 120, the data entry person may repeat the data entry process for each digital file 32 until there are no more digital files left to be processed.

Once data entry has been completed, a quality control or quality assurance step may be performed in accordance with block 122. As described above, this may involve reviewing the entered attribute data and correcting erroneous data. In a final step, a deliverable providing the results of the joint use audit to the customer is created in block 124.

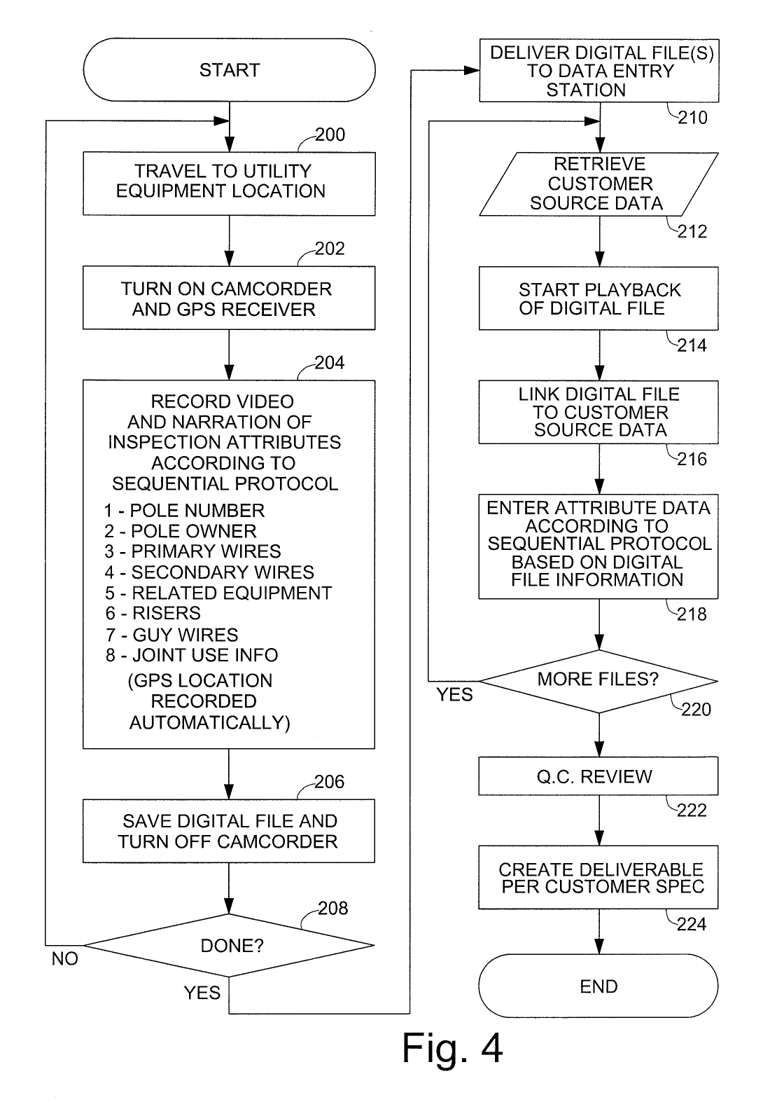

FIG. 4 is a flow diagram illustrating another example of how the method of the present invention may be applied. In the example of FIG. 4, the method is applied to a network inventory audit, wherein the primary objective is to create an inventory of the equipment installed at each audited location, for example at specified utility poles. The method is essentially similar to that shown and described in connection with FIG. 3, with counterpart blocks in FIG. 4 being numbered 200, 202, 204 etc. to indicate correspondence with blocks 100, 102, 104 etc. in FIG. 3. However, different information is captured in the network inventory audit. As may be seen, the protocol used in block 204 for the network inventory audit differs from that used in counterpart block 104 of FIG. 3 for the joint use audit, however joint use information may be collected as part of the inventory audit. The other blocks are the same as their counterparts in FIG. 3. During block 204 of the network inventory audit process, the video and voice narration may be carried out in accordance with a predetermined sequential protocol. For example, the field technician starts by recording video of the pole number if the pole is visibly tagged, and at the same time reading the pole number aloud. The field technician may then record video evidence of pole ownership, if available, and say the pole owner's name as part of the voice narration. In similar fashion, the field technician may record video and voice commentary with respect to other items of interest, such as primary wires (orientation, wire size, type, material, whether they are covered, etc.), secondary wires (orientation, wire size, type, material, whether they are covered, etc.), related equipment (switches, fuses, transformers, reclosers, regulators, etc. with attributes describing each item), risers to protect wires running down the pole to an underground conduit), guy wires, and joint use information as described above in connection with FIG. 3. Of course other items may be included as desired. The GPS location coordinates are recorded automatically in a manner described above. Apart from block 204 and its counterpart block 104, the blocks in FIG. 4 are the same as their respective counterparts in FIG. 3.

It will be understood that data and information collected using the method of the present invention provides a snapshot at a particular point time. Therefore, the method may be repeated periodically to update the data and information in central database 54 as desired.

While the invention has been described in connection with various exemplary embodiments, the detailed description is not intended to limit the scope of the invention to the particular forms set forth. The invention is intended to cover such alternatives, modifications, and equivalents of the described embodiment as may be included within the spirit and scope of the invention.

What is claimed is:

1. A method for capturing information regarding utility equipment installed at a location, the method comprising the steps of:
making a site visit to the location;
recording voice narration about the utility equipment as the utility equipment is inspected by a narrator during the site visit;
recording video of the utility equipment during the site visit;
recording identification information for identifying the utility equipment; and
entering attribute data corresponding to the utility equipment into a database, wherein the entered attribute data includes data derived from the recorded voice narration, the recorded video, and the recorded identification information.

2. The method according to claim 1, wherein the steps of recording voice narration, recording video, and recording identification information are performed simultaneously.

3. The method according to claim 2, wherein the identification information includes location coordinates corresponding to the location where the utility equipment is installed, the location coordinates being provided automatically by a GPS receiver.

4. The method according to claim 3, wherein the voice narration, the video, and the location coordinates are stored in a single digital file.

5. The method according to claim 4, wherein the digital file includes a stream of voice audio data corresponding to the voice narration, a stream of video data corresponding to the video, and a stream of audio frequency shift keying (AFSK) data corresponding to the location coordinates.

6. The method according to claim 1, wherein the step of recording video is performed using a digital video camera having an optical zoom providing magnification power of at least 10×.

7. The method according to claim 1, wherein the steps of recording voice narration and recording video are performed by a narrator providing the voice narration.

8. The method according to claim 1, wherein the steps of recording voice narration and recording video are performed at the location according to a predetermined sequential protocol.

9. The method according to claim 8, wherein the step of entering attribute data is performed in accordance with the predetermined sequential protocol.

10. The method according to claim 1, further comprising the steps of:
receiving additional data about the utility equipment from an outside source; and
integrating the additional data into the database.

11. The method according to claim 1, wherein the utility equipment includes one or more items selected from the group consisting of a utility pole, an underground utility pad, a customer meter, power lines, transformers, telecommunication lines, and switches.

12. The method according to claim 1, further comprising the steps of:
reviewing the recorded voice narration and the recorded video in conjunction with the entered attribute data to check accuracy of the entered attribute data; and
if necessary, correcting the entered attribute data.

13. The method according to claim 1, further comprising the step of storing the recorded voice narration, the recorded video, and the recorded identification information in the database.

14. A method for capturing information regarding utility equipment installed at a location, the method comprising the steps of:
making a site visit to the location;
recording video of the utility equipment during the site visit to provide objective information about the utility equipment;
narrating the video with voice narration as the video is recorded;
recording the voice narration to provide subjective information about the utility equipment; and
entering attribute data corresponding to the utility equipment into a database, wherein the entered attribute data includes data derived from the objective information and the subjective information.

15. The method according to claim 14, further comprising the step of recording identification information for identifying the utility equipment.

16. The method according to claim 15, wherein the steps of recording video, recording voice narration, and recording identifying information are performed simultaneously.

17. The method according to claim 16, wherein the identifying information includes location coordinates corresponding to the location where the utility equipment is installed, the location coordinates being provided automatically by location sensing equipment.

18. The method according to claim 17, wherein the video, the voice narration, and the location coordinates are stored in a single data file.

19. The method according to claim 18, wherein the digital file includes a stream of video data corresponding to the video, a stream of voice audio data corresponding to the voice narration, and a stream of audio frequency shift keying (ASFK) data corresponding to the location coordinates.

20. The method according to claim 14, wherein the step of recording video is performed using a digital video camera having an optical zoom providing magnification power of at least 10×.

21. The method according to claim 14, wherein the steps of recording video and recording voice narration are performed by a narrator providing the voice narration.

22. The method according to claim 14, wherein the steps of recording video and recording voice narration are performed at the location according to a predetermined sequential protocol.

23. The method according to claim 22, wherein the step of entering attribute data is performed in accordance with the predetermined sequential protocol.

24. The method according to claim 14, further comprising the steps of:
receiving additional data about the utility equipment from an outside source; and
integrating the additional data into the database.

25. The method according to claim 14, wherein the utility equipment includes one or more items selected from the group consisting of a utility pole, an underground utility pad, a customer meter, power lines, transformers, telecommunication lines, and switches.

26. The method according to claim 14, further comprising the steps of:
reviewing the recorded voice narration and the recorded video in conjunction with the entered attribute data to check accuracy of the entered attribute data; and
if necessary, correcting the entered attribute data.

27. The method according to claim 14, further comprising the step of storing the objective information and the subjective information in the database.
